(19) United States
(12) Patent Application Publication
(10) Pub. No.: US 2025/0348761 A1
(43) Pub. Date: Nov. 13, 2025

(54) AUTOMATIC KNOWLEDGE GRAPH CONSTRUCTION METHOD BASED ON PRIOR KNOWLEDGE AND KNOWLEDGE CONNECTION

(71) Applicant: Kunming University of Science and Technology, Kunming (CN)

(72) Inventors: Qingwang Wang, Kunming (CN); Chaohui Li, Kunming (CN); Haibin Yuan, Kunming (CN); Tao Shen, Kunming (CN); Sheng Lei, Kunming (CN); Wanli Xu, Kunming (CN)

(73) Assignee: Kunming University of Science and Technology, Kunming, YN (CN)

(21) Appl. No.: 19/274,633

(22) Filed: Jul. 20, 2025

(30) Foreign Application Priority Data
Jul. 22, 2024 (CN) 202410978360.2

(51) Int. Cl. G06N 5/022; G06F 16/215

(52) U.S. Cl. CPC G06N 5/022; G06F 16/215

(57) ABSTRACT

An automatic knowledge graph construction method based on prior knowledge and knowledge connection is disclosed. The method includes obtaining prompt data by storing relevant topic information for constructing a knowledge graph as character strings; retrieving and saving article paragraphs from external data source based on the prompt data; respectively injecting prompt templates for four large language model agents of annotation, reasoning, cognition, and association; obtaining prior knowledge by inputting the injected prompt templates, article paragraphs, and specific task requirements into the agents; obtaining effective data related to the knowledge graph topic by inputting the article paragraphs, prior knowledge, and a pre-defined contrasting prompt text into a knowledge-connecting large language model; and configuring the effective data related to the knowledge graph topic and pre-defined input prompts as an input layer of a large language model automatic agent framework, obtaining entity-relation-entity triples, and completing the construction of the knowledge graph.

### TECHNICAL FIELD

The present disclosure relates to an automatic knowledge graph construction method based on prior knowledge and knowledge connection, and belongs to the field of natural language processing.

### BACKGROUND

Knowledge graphs comprehensively record concepts, entities, and their interrelations in the objective world in a graphical format, so as to simulate the way that humans understand the cognitive world. This form of expression gives us the ability to organize, manage, and understand professional domain information more effectively. Therefore, it has become crucial to construct knowledge graphs in various domains. Nevertheless, conventional knowledge graph construction methods mainly rely on manual annotation and manual collation of expert knowledge, and this method typically cannot efficiently extract entities, attributes, and relations from text, limiting the speed and scale of knowledge graph construction. In this context, the cost of manually constructing knowledge graphs can be effectively reduced by using large language models, while improving the accuracy and completeness of knowledge graphs. Therefore, automatic knowledge graph construction methods based on large language models have become a major research direction in the field of natural language processing.

The automatic domain knowledge graph construction based on the large language models faces a series of problems, such as unreliable data, poor understanding of domain professional knowledge, and inaccurate extraction of original corpus knowledge. Moreover, as a general model, large language models cannot construct high-precision, high-completeness domain knowledge graphs in specific domains.

### SUMMARY

The technical problem to be solved by the present disclosure is to provide an automatic knowledge graph construction method based on prior knowledge and knowledge connection, which aims to deal with the problems faced by conventional knowledge graph construction methods, including high manual construction cost, low accuracy and incompleteness, so as to achieve efficient and accurate knowledge graph automatic construction. By introducing prior knowledge, the problems of inaccurate and unreliable knowledge extraction in the construction of a domain knowledge graph by a large language model can be effectively solved. By introducing knowledge connection technology, the problems of low knowledge extraction effectiveness and poor accuracy when using a generative large language model to construct a knowledge graph based on external data can be effectively solved.

The technical solution adopted by the present disclosure is: an automatic knowledge graph construction method based on prior knowledge and knowledge connection, including the following steps:
Step 1: obtaining prompt data by storing relevant topic information for constructing a knowledge graph as character strings;
Step 2: retrieving and saving article paragraphs from an external data source based on the prompt data;
Step 3: respectively injecting prompt templates for four large language model agents of annotation, reasoning, cognition, and association;
Step 4: obtaining prior knowledge by inputting the injected prompt templates, article paragraphs, and specific task requirements into the four large language model agents;
Step 5: obtaining effective data related to the knowledge graph topic by inputting the article paragraphs, prior knowledge, and a pre-defined contrasting prompt text into a knowledge-connecting large language model; and
Step 6: configuring the effective data related to the knowledge graph topic and pre-defined input prompts as an input layer of a large language model automatic agent framework, obtaining entity-relation-entity triples through multi-round feedback of the large language model, and completing the construction of the knowledge graph.

The specific steps of Step 1 are as follows:
Step 1.1: converting all original corpus data in different formats, including text, voice, and Portable Document Format (PDF) images from actual scenarios, into a unified character text and performing preliminary integration to obtain original character data; and
Step 1.2: performing data cleaning on the original character data to eliminate blank data and redundant data, and obtaining prompt data.

The specific steps of Step 2 are as follows:
Step 2.1: configuring the prompt data as an input to a retrieval framework;
Step 2.2: retrieving the paragraph text with a highest similarity to the prompt data from the pre-saved document external data source according to the maximum likelihood estimation search algorithm; and
Step 2.3: saving the retrieved paragraph text in the character string format.

The specific steps of Step 3 are as follows:
Step 3.1: injecting the cognitive prompt template according to an expected function of the cognitive agent;
Step 3.2: injecting the annotation prompt template according to an expected function of the annotation agent;
Step 3.3: injecting the reasoning prompt template according to an expected function of the reasoning agent; and
Step 3.4: injecting the associative prompt template according to an expected function of the associative agent.

The specific steps of Step 4 are as follows:
Step 4.1: inputting the injected prompt template as data correlation requirements to four large language model agents;
Step 4.2: inputting the article paragraphs as an extraction corpus to four large language model agents;
Step 4.3: inputting the pre-defined generated data format as specific task requirements to four large language model agents; and
Step 4.4: generating prior knowledge related to the graph topic by the four large language model agents from four aspects based on the input data from Step 4.1 to Step 4.3.

The specific steps of Step 5 are as follows:
Step 5.1: configuring the article paragraphs as extraction data and the prior knowledge as reference data;
Step 5.2: configuring the pre-defined contrastive prompt text as prompt instructions and inputting to the knowledge-connecting large language model;
Step 5.3: based on the prompt instructions, extracting extended information of prior knowledge from the article paragraphs by the large language model using the prior knowledge as the standard; and
Step 5.4: obtaining effective data related to the knowledge graph topic by integrating the prior knowledge with the extended information.

The specific steps of Step 6 are as follows:
Step 6.1: setting agent types of two large language models in the automatic agent framework as “customer” and “knowledge graph construction expert”;
Step 6.2: transmitting the effective data related to the knowledge graph topic to the “customer” as context, and transmitting an input prompt to the “knowledge graph construction expert” as the instruction; and
Step 6.3: according to multiple rounds of feedback, obtaining the triple data included in the local knowledge graph obtained by each feedback, and finally obtaining the complete knowledge graph.

The beneficial effect of the present disclosure is that the prior knowledge method solves the problems of data verification difficulties in a specific scenarios, incomplete data validation related to the knowledge graph theme, thereby enhancing the integrity and reliability of the knowledge graph. The knowledge connection method is used to solve the problems of low controllability and low accuracy of using large language models as reasoning engines, and improves the accuracy of knowledge graphs. The large language model feedback agent framework is used as the main body of automatic construction, enabling the dialogue feedback process can be applied to the automatic construction of domain knowledge graphs, thereby limiting manual construction costs.

### BRIEF DESCRIPTION OF THE DRAWINGS

FIG. 1 is a general flow diagram of the present disclosure.

### DETAILED DESCRIPTION OF THE EMBODIMENTS

The following is a further description of the present disclosure with reference to the accompanying drawings and specific embodiments.

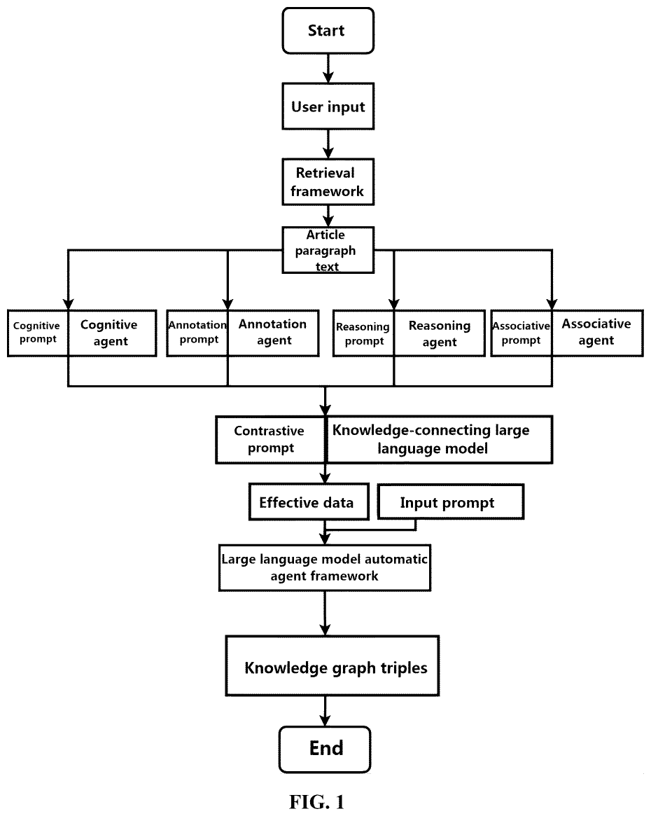

Embodiment 1: as shown in FIG. 1, the specific steps of an automatic knowledge graph construction method based on prior knowledge and knowledge connection are as follows:

Step S1: the expert-input texts such as “The smelting method of tin metal mainly depends on the material composition and content of the ore. Generally dominated by pyrometallurgy with hydrometallurgy as auxiliary”, expert-conveyed audio recordings, internet-related PDF images of tin smelting, and internal enterprise materials are converted into unified character texts through Baidu Speech Recognition and PaddleOCR recognition for preliminary integration, thereby obtaining the original character data. The data cleaning is performed on the original character data to eliminate blank data and redundant data, and the prompt data is obtained.

Step S2: the prompt data of step S1 and the total task requirement of “identifying the ore, devices, gas, temperature, humidity and other related paragraphs contained in the relevant tin smelting process” are used as the input of the retrieval framework, the retrieval framework retrieves the relevant text paragraphs according to the maximum likelihood estimation search algorithm and saves them as character strings.

Step S3: the text: “You are an expert in the field of cognitive science, please answer the following questions: I will provide you with several retrieved paragraphs: {paragraphs} please extract from these paragraphs the basic knowledge that the model may be familiar with or advanced information beyond the basic knowledge that the model is already familiar with, and analyze the role of these contents. Summarize and consolidate this content, which should deepen the understanding of model for the problem by familiarizing with this basic and advanced information. This process is aimed to encourage the model to understand the problem more thoroughly and expand its knowledge boundaries.” as the cognitive prompt template is input to the cognitive agent; the text: “You are an expert in the field of cognitive science, to answer the following questions: Question {Question} I will provide you with several retrieved paragraphs: { } Task description: Please extract content from these paragraphs that the model may be unfamiliar with, the content can provide the model with relevant background and unknown knowledge and concepts, to help it better understand the problem, and analyze the role of these contents.” as the annotation prompt template is input to the annotation agent; the text: “You are an expert in the field of logic, answer the following questions: Question {Question} I will provide you with some retrieved paragraphs: Paragraph: {Paragraph} Task Description: Please extract content from these paragraphs that will help enhance the causal reasoning and logical reasoning ability of the model. To consolidate this content, and analyze how the selected information may affect the improvement of the causal reasoning and logical reasoning ability of model.” as the reasoning prompt template is input to the reasoning agent; the text: “Fact checking refers to the process of confirming the accuracy of a statement or a claim through a variety of sources or methods, the process ensures that the statement or claim is based on reliable and verifiable information, while eliminating inaccurate or misleading content. Fact checking may involve examining data, literature, expert opinions, or other credible sources. In order to answer the following questions: {Question}, I will provide with some retrieved paragraphs: Paragraphs: {Paragraphs} Task Description: Please extract content from these paragraphs that may contradict the existing knowledge of the model. Identifying the information, when adding the information, the knowledge of the model can be updated and the factual errors can be prevented, the model illusions can be mitigated. Please note that these paragraphs are retrieved from authoritative knowledge bases, so they are assumed to be correct.” as the associative prompt template is input to the associative agent.

Step S4: the above injected prompt template as data correlation requirements are input to the above four large language model agents. The article paragraphs as the extraction corpus are input to four large language model agents. The requirements such as the pre-defined generated data format, as task-specific requirements are input to the above four large language model agents. The prior knowledge related to the graph topic is generated by the agents from four aspects based on the input data.

Step S5: the article paragraphs are configured as extraction data and the prior knowledge is configured as reference data; the pre-defined contrastive prompt text data “according to your existing knowledge information, I will give you the text {text}, please extract relevant knowledge from it, eliminate the knowledge information that contradicts your cognition, and integrate the relevant knowledge into text data” as the prompt instruction, and input to the knowledge-connecting large language model; based on the prompt instruction, the knowledge-connecting large language model takes the prior knowledge as the standard, and extracts the extended information of the relevant prior knowledge from the article paragraph; the effective data related to the knowledge graph topic is obtained by integrating the prior knowledge with the extended information.

Step S6: firstly, agent types of the two large language models in the Auto-GPT automatic agent framework are set as “customer” and “knowledge graph construction expert”. The effective data related to the knowledge graph topic is transmitted to the “customer” as context, and the input prompt is transmitted to the “tin smelting knowledge graph construction expert” as instructions. According to multiple rounds of feedback, the triple data included in the local knowledge graph obtained by each feedback is obtained, and finally, the complete knowledge graph is obtained.

The above description of the specific embodiments of the present disclosure has been provided with reference to the accompanying drawings. However, the present disclosure is not limited to the above embodiments. Within the scope of the knowledge available to those skilled in the art, various modifications may be made without departing from the spirit and scope of the present disclosure.

What is claimed is:

1. An automatic knowledge graph construction method based on prior knowledge and knowledge connection, comprising the following steps:
Step 1: obtaining prompt data by storing relevant topic information for constructing a knowledge graph as character strings;
Step 2: retrieving and saving article paragraphs from an external data source based on the prompt data;
Step 3: respectively injecting prompt templates for four large language model agents of annotation, reasoning, cognition, and association;
Step 4: obtaining prior knowledge by inputting the injected prompt templates, article paragraphs, and specific task requirements into the four large language model agents;
Step 5: obtaining effective data related to the knowledge graph topic by inputting the article paragraphs, prior knowledge, and a pre-defined contrasting prompt text into a knowledge-connecting large language model; and
Step 6: configuring the effective data related to the knowledge graph topic and pre-defined input prompts as an input layer of a large language model automatic agent framework, obtaining entity-relation-entity triples through multi-round feedback of the large language model, and completing the construction of the knowledge graph;
wherein Step 5 is as follows:
Step 5.1: configuring the article paragraphs as extraction data and the prior knowledge as reference data;
Step 5.2: configuring the pre-defined contrastive prompt text as prompt instructions and inputting to the knowledge-connecting large language model;
Step 5.3: based on the prompt instructions, extracting extended information of prior knowledge from the article paragraphs by the large language model using the prior knowledge as the standard; and
Step 5.4: obtaining effective data related to the knowledge graph topic by integrating the prior knowledge with the extended information.

2. The automatic knowledge graph construction method based on prior knowledge and knowledge connection according to claim 1, wherein Step 1 is as follows:
Step 1.1: converting all original corpus data in different formats, comprising text, voice, and PDF images from actual scenarios, into a unified character text and performing preliminary integration to obtain original character data; and
Step 1.2: performing data cleaning on the original character data to eliminate blank data and redundant data, and obtaining prompt data.

3. The automatic knowledge graph construction method based on prior knowledge and knowledge connection according to claim 1, wherein Step 2 is as follows:
Step 2.1: configuring the prompt data as an input to a retrieval framework;
Step 2.2: retrieving the paragraph text with a highest similarity to the prompt data from the pre-saved document external data source according to a maximum likelihood estimation search algorithm; and
Step 2.3: saving the retrieved paragraph text in the character string format.

4. The automatic knowledge graph construction method based on prior knowledge and knowledge connection according to claim 1, wherein Step 3 is as follows:
Step 3.1: injecting the cognitive prompt template according to an expected function of the cognitive agent;
Step 3.2: injecting the annotation prompt template according to an expected function of the annotation agent;
Step 3.3: injecting the reasoning prompt template according to an expected function of the reasoning agent; and
Step 3.4: injecting the associative prompt template according to an expected function of the associative agent.

5. The automatic knowledge graph construction method based on prior knowledge and knowledge connection according to claim 1, wherein Step 4 is as follows:
Step 4.1: inputting the prompt template as data correlation requirements to four large language model agents;
Step 4.2: inputting the article paragraphs as an extraction corpus to four large language model agents;
Step 4.3: inputting the pre-defined generated data format as specific task requirements to four large language model agents; and
Step 4.4: generating prior knowledge related to the graph topic by the four large language model agents from four aspects based on the input data from Step 4.1 to Step 4.3.

6. The automatic knowledge graph construction method based on prior knowledge and knowledge connection according to claim 1, wherein Step 6 is as follows:
Step 6.1: setting agent types of two large language models in the automatic agent framework as “customer” and “knowledge graph construction expert”;
Step 6.2: transmitting the effective data related to the knowledge graph topic to the “customer” as context, and transmitting an input prompt to the “knowledge graph construction expert” as the instruction; and
Step 6.3: according to multiple rounds of feedback, obtaining the triple data comprised in the local knowledge graph obtained by each feedback, and finally obtaining the complete knowledge graph.
